(19) United States
(12) Patent Application Publication
(10) Pub. No.: US 2007/0027763 A1
(43) Pub. Date: Feb. 1, 2007

(54) Interactive advertisement board

(76) Inventors: David Yen, Burnaby (CA); Ting-Hung Huang, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/429,986

(22) Filed: May 9, 2006

(30) Foreign Application Priority Data
Jul. 28, 2005 (TW) 94125657

(51) Int. Cl. G06Q 30/00

(52) U.S. Cl. 705/14

(57) ABSTRACT

The present invention provides an interactive advertisement board that includes a display module, a sensor module and a display control module. The sensor module and the control module are coupled to the display module either physically or offsite through a communication means. This sensor module is used to detect and monitor environmental conditions and send the results to the display control module. The display control module is used to manage the timing, frequency and type of special advertisement that will be shown on the display in accordance with the environmental conditions.

### RELATED APPLICATIONS

The present application is based on, and claims priority from, Taiwan Application Serial Number 94125657, filed Jul. 28, 2005, the disclosure of which is hereby incorporated by reference herein in its entirety.

### FIELD OF THE INVENTION

The present invention is about an advertisement board, and more particularly is about an interactive advertisement board.

### BACKGROUND OF THE INVENTION

Using an advertisement board to advertise a new product or service of a company to a customer is a popular marketing method.

A typical advertisement board can only show a fixed picture of a product.The customer can get a stronger impression of this product due to the fixed content, but such a fixed advertising method provides limited information for this product and cannot provide different product information to different consumption groups.

Hence, advertisement boards that can display video of products often replace the fixed picture advertisement boards. A video for a product is recorded first. Then, this video is repeatedly displayed on the advertisement board. This advertising method can provide more vivid product information to customers. Different videos can also be displayed at different times. Therefore, the advertisement efficiency is better than that of the fixed picture advertisement board.

Nonetheless, both of these advertising methods are passive. That is, the content, no matter whether fixed or in motion, and the broadcast duration of the advertisement are all predetermined, and then the advertisement is broadcast according to the set time. In other words, even when a special event happens, the advertisement cannot change to compliment this event. Consequently, both methods may not reach best advertisement efficiency.

Therefore, an advertisement board that can display different advertisements according to environmental conditions is required.

### SUMMARY OF THE INVENTION

Therefore, the main purpose of the present invention is to provide an advertisement board that can display different advertisements according to different environmental conditions.

The other purpose of the present invention is to provide an advertisement board that can automatically arrange a special advertisement to display according to environmental conditions.

Accordingly, the present invention provides an interactive advertisement board that includes a display module, a sensor module and a display control module. The sensor module and the control module are coupled to the display either physically or offsite through a communication means. This sensor module is used to detect and monitor environmental conditions and send the results to the display control module. The display control module is used to manage the timing, frequency and type of special advertisement that will be shown on the display in accordance with the environmental conditions.

In another embodiment, the present invention provides an interactive advertisement board that includes a display module, an input module, a sensor module and a display control module. The sensor module and the control module are coupled to the display either physically or offsite through a communication means. This sensor module is used to detect and monitor the environmental conditions and send the results to the display control module. The display control module is used to manage the timing, frequency and type of special advertisement that will be shown on the display in accordance with the environmental conditions. The input module is coupled to the display module. A customer may input a command from this input module.

In yet another embodiment, the present invention provides an advertising method. First, the relationship between the sensor module and the advertisements is set. Then, the sensor module may detect and monitor environmental conditions and send the results to the display control module. special advertisement will be shown on the display in accordance with the environmental conditions.

### BRIEF DESCRIPTION OF THE DRAWINGS

The foregoing aspects and many of the attendant advantages of this invention will become more readily appreciated and better understood by referencing the following detailed description, when taken in conjunction with the accompanying drawings, wherein:

FIG. 1 illustrates a schematic diagram of an interactive advertisement board according to the present invention.

FIG. 2 illustrates a flow chart for operating the interactive advertisement board of the present invention.

FIG. 3 illustrates a schematic diagram of an interactive advertisement board according to another embodiment of the present invention.

### DETAILED DESCRIPTION OF THE PREFERRED EMBODIMENT

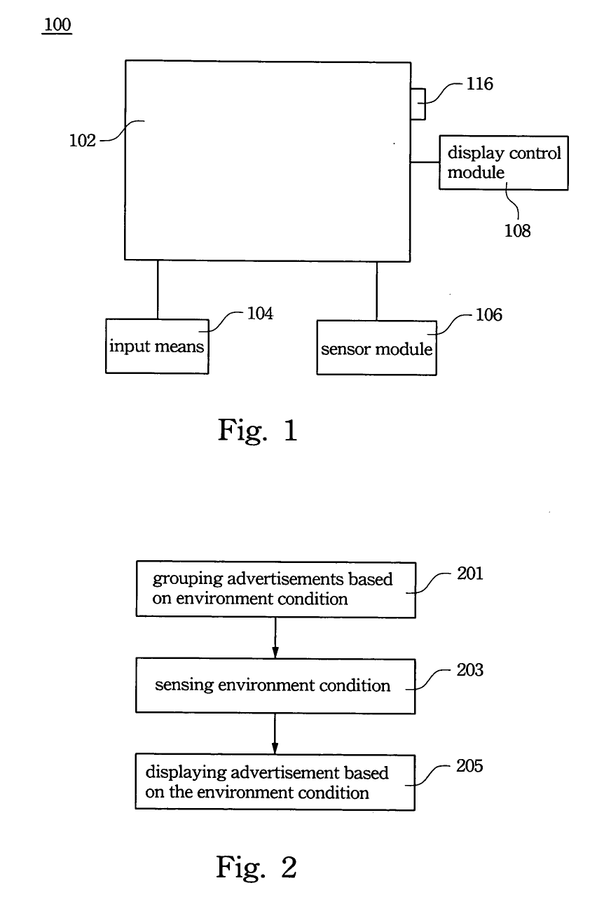

FIG. 1 illustrates a schematic diagram of an interactive advertisement board according to the present invention. The interactive advertisement board 100 includes a display module 102, an input module 104, a sensor module 106 and a display control module 108.

The sensor module 106 and the display control module 108 are coupled to the display 102. This sensor module 106 is used to detect and monitor environmental conditions and send the results to the display control module 108. The display control module 108 is used to manage the timing, frequency and type of special advertisement that will be shown on the display in accordance with the environmental conditions.

There are many different advertisements stored in the display control module 108. A corresponding relationship between each advertisement and the sensor module 106 is set first. When a special environmental event happens, the display control module 108 controls a corresponding advertisement to display in the display module 102.

The sensor module 106 is a temperature sensor, a humidity sensor, a color sensor, a sound sensor, a speed sensor, or other sensor or combination of sensors. The input module 104, such as a mouse or a keyboard, is coupled to the display module 102. A customer can input a command through the input module 104 to interact with the interactive advertisement board 100. The display module is a TV, an LCD, an LED display, or another display. It is noticed that the display control module 108 and the display module 102 are connected together either physically or offsite through a communication means. Therefore, the display control module 108 may remotely control the display module.

In one embodiment, if the sensor module 106 is a temperature sensor in the interactive advertisement board 100, such that the detected environmental condition is the environmental temperature. Before using the interactive advertisement board 100 to display advertisements, a corresponding relationship between each advertisement and the sensor module 106 is set first. The sensor module 106 may continue to detect and monitor the environmental temperature while displaying an advertisement.

For example, if the advertisement content is of an ice cream product, a drink product or summer clothes, the desirability of these products are proportional to the temperature. In other words, higher temperatures will increase the desire to buy, and advertising these products in a higher temperature may promote the advertisement efficiency. When advertising, a critical temperature may be set in the display control module 108. When the sensor module 106 detects that the environmental temperature is larger than the critical temperature, the interactive advertisement board 100 is forced to broadcast the foregoing advertisements by the display control module 108.

It is noticed that these advertisements can be grouped according to the temperature level. When the sensor module 106 detects a special temperature level and sends the result to the display control module 108, an advertisement group corresponding to the special temperature is displayed in the display 102. For example, these advertisements can be grouped into three groups based on different temperature levels. The first advertisement group is related to the temperature level from 23° C. to 24° C.; the second advertisement group is related to the temperature level from 24° C. to 26° C.; and the third advertisement group is related to the temperature level from 26° C. to 28° C. When advertising, the sensor module 106 detects the environmental temperature and communicates to the display control module 108 the detected temperature. If the detected temperature is 25° C., the display control module 108 controls the interactive advertisement board 100 to broadcast the second advertisement group. Accordingly, the broadcasting advertisement is changeable based on the environmental temperature in the present invention. Therefore, the ice cream product advertisement would not be broadcast in a low environmental temperature according to the present invention.

On the other hand, when the interactive advertisement board 100 is set up adjacent to a main road to display advertisements to drivers and passengers, the sensor module 106 is a speed sensor for detecting the average speed of the vehicles. Similarly, a corresponding relationship between each advertisement and the sensor module 106 is set first. In this embodiment, when the average speed of the vehicles is very high, it is impossible for the drivers or the passengers to see a whole video-type advertisement in the moment of passing the interactive advertisement board 100. Therefore, an advertisement with a fixed picture is better under such an environmental condition. However, when a traffic jam happens, the drivers and the passengers are captivated more by a video-type advertisement. Therefore, in this embodiment, a certain speed is set in the display control module 108 first. Then, the sensor module 106 detects the average speed of the vehicles and communicates to the display control module 108 the detected results. If the detected average speed is lower than the set speed, the display control module 108 controls the interactive advertisement board 100 to broadcast a video-type advertisement in the display 102. If the detected average speed is higher than the set speed, the display control module 108 controls the interactive advertisement board 100 to show a fixed picture in the display 102.

Accordingly, the average speed of the vehicles is changeable according to the traffic situation. An advertisement with a fixed picture would not be displayed to the drivers and the passengers when they are in a traffic jam. On the other hand, it is impossible to give the drivers and the passengers all of the information in a video-type advertisement when the cars are moving at high speed. Therefore, the display control module 108 controls the interactive advertisement board 100 to change the advertisements according to the average speed of the vehicles detected by the sensor module 106.

It is noticed that different sensors can be integrated into a sensor module 106 to detect different environmental conditions together in other embodiments. By such integration, a fittest advertisement can be broadcast. For example, a speed sensor and a temperature sensor may be integrated into a sensor module 106. In this embodiment, two environmental conditions, the average speed of traffic and the environmental temperature, are detected at the same time and are considered together. Thus, when a set temperature is reached, a special advertisement is broadcast depending on the detected average speed of the vehicles. If the average speed is larger than the set speed, a fixed-picture advertisement is broadcast; and if the average speed is less than the set speed, a video-type advertisement is broadcast.

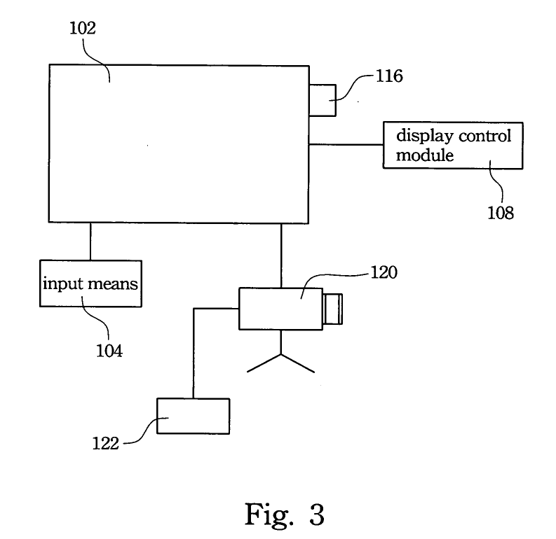

As shown in the FIG. 3, the sensor module 106 of the present invention is composed of a video camera 120 and an analysis module 122 in yet another embodiment. The video camera 120 is used to record the picture of the environment. Then, the analysis module 122 analyzes the picture and sends the analyzed results to the display control module 108 to broadcast a corresponding advertisement.

For example, the video camera 120 captures a picture of people. Then, the analysis module 122 analyzes the picture to detect clothing color of the majority of people. Finally, the detected results are sent to the display control module 108 to broadcast a corresponding advertisement. It is noticed that the analysis module 122 can, for example, detect the number or average speed of vehicles, or the color, number or average walking speed of people.

It is noticed that a shop sign can also use the technology disclosed in the present invention. For example, a speed sensor can be installed in the shop sign to detect the average speed of vehicles. When the detected average speed is less than a certain speed, a video-type advertisement is displayed in the shop sign to inform the products of this shop to people. When the detected average speed is larger than a certain speed, the shop name is displayed in the shop sign.

Additionally, an input means 104 is installed in the interactive advertisement board 100 of the present invention. A customer can make a response to the advertisement through this input means 104. Moreover, a connect means 116 can be installed in the interactive advertisement board 100 so as to provide a physical or wireless communication with a base station to renew the advertisements.

FIG. 2 illustrates a flow chart for operating the interactive advertisement board of the present invention. Before using the interactive advertisement board 100 to display advertisements, a corresponding relationship between each advertisement and the sensor module 106 is set first in step 201. For example, in an embodiment, if the sensor module 106 is a temperature sensor, the detected environmental condition is the temperature. Therefore, these advertisements can be grouped according to the temperature level. Next, in step 203, the sensor module 106 may continue to detect and monitor the environment temperature and send the detected results to the display control module 108. Finally, in step 205, a special advertisement group will be shown on the display 102 by the display control module 108 in accordance with the environmental condition.

Accordingly, the interactive advertisement board of the present invention includes a display module, a sensor module and a display control module. The sensor module is used to detect and monitor environmental conditions and send the results to the display control module. The display control module is used to manage the timing, frequency and type of special advertisement that will be shown on the display in accordance with the environmental conditions.

As is understood by a person skilled in the art, the foregoing descriptions of the preferred embodiment of the present invention are an illustration of the present invention rather than a limitation thereof. Various modifications and similar arrangements are included within the spirit and scope of the appended claims. The scope of the claims should be accorded to the broadest interpretation so as to encompass all such modifications and similar structures. While a preferred embodiment of the invention has been illustrated and described, it will be appreciated that various changes can be made therein without departing from the spirit and scope of the invention.

What is claimed is:

1. An advertisement board apparatus, comprising:
a display apparatus;
a sensor module coupling with said display apparatus to detect an environmental condition and send a detected value; and
a display control module coupling with said display apparatus for receiving said detected value and outputting a corresponding advertisement based on said detected value to said display apparatus for displaying.

2. The apparatus according to claim 1, further comprising an input module coupled to said display apparatus, wherein a customer may make a response based on an advertisement through said input module.

3. The apparatus according to claim 2, wherein said input means is a keyboard.

4. The apparatus according to claim 2, wherein said input means is a mouse.

5. The apparatus according to claim 1, wherein said display apparatus is a TV.

6. The apparatus according to claim 1, wherein said display apparatus is an LED display.

7. The apparatus according to claim 1, wherein said display apparatus is an LCD.

8. The apparatus according to claim 1, wherein said sensor module comprises a sensor.

9. The apparatus according to claim 8, wherein said sensor is a temperature sensor, a humidity sensor, a color sensor, a sound sensor, a speed sensor or a combination thereof.

10. The apparatus according to claim 1, wherein said environmental condition is the environmental temperature, the environmental humidity, the environmental color, the environmental sound, the environmental speed or a combination thereof.

11. The apparatus according to claim 1, further comprising a connecting means for connecting with the Internet.

12. The apparatus according to claim 1, wherein the communication between said display control module and said display apparatus is wireless communication.

13. The apparatus according to claim 1, wherein said sensor module comprises a video camera and an analysis module, wherein said analysis module may analyze images taken by said video camera.

14. The apparatus according to claim 13, wherein said analysis module may detect the number of people, the number of vehicles, the average speed of vehicles, the color of people, the distance walked by people, or the walking speed of people.

15. A displaying advertisement method, comprising:
grouping advertisements based on at least one environmental condition;
sensing said at least one environmental condition and generating a result value; and
displaying a corresponding advertisement based on said result value.

16. The method according to claim 15, wherein said at least one environmental condition is the environmental temperature, the environmental humidity, the environmental color, the environmental sound, the environmental speed or a combination thereof.

17. The method according to claim 15, wherein sensing said at least one environmental condition is by a temperature sensor, a humidity sensor, a color sensor, a sound sensor, a speed sensor or a combination thereof.

18. The method according to claim 15, wherein sensing said at least one environmental condition is by a video camera and an analysis module, wherein said analysis module may detect images captured by said video camera.

19. The apparatus according to claim 15, wherein said analysis module may detect the number of people, the number of vehicles, the average speed of vehicles, the color of people, the distance walked by people, or the walking speed of people.
